(19) United States
(12) Patent Application Publication
(10) Pub. No.: US 2015/0157173 A1
(43) Pub. Date: Jun. 11, 2015

(54) OVEN WITH ROTATING COOKING SURFACE

(71) Applicants: Andrew Jepsen, Oconomowoc, WI (US); Timothy McQuiston, Elkhart Lake, WI (US)

(72) Inventors: Andrew Jepsen, Oconomowoc, WI (US); Timothy McQuiston, Elkhart Lake, WI (US)

(21) Appl. No.: 14/564,980

(22) Filed: Dec. 9, 2014

Related U.S. Application Data
(60) Provisional application No. 61/913,700, filed on Dec. 9, 2013.

(51) Int. Cl. A47J 37/07

(52) U.S. Cl. CPC A47J 37/0745

(57) ABSTRACT

An oven including a housing (e.g., cylindrically shaped) defining a first central axis, and a cooking surface (e.g., disc-shaped and mounted for rotation) in the housing and having a second central axis offset from the first central axis. A rear edge of the cooking surface can be spaced from a rear of the housing to define a rear gap, and a front edge of the cooking surface can be spaced from a front of the housing to define a front gap smaller than the rear gap. A heat deflector can be mounted in the housing below the cooking surface, and a heat source can be positioned between the heat deflector and the cooking surface. Preferably, the position of the heat source relative to the cooking surface is adjustable. The oven can further include second and third cooking surfaces that are aligned with the housing.

### BACKGROUND

The present invention relates generally to the field of outdoor cooking appliances, such as gas ovens.

Gas grills are commonly used to cook food outdoors. Such grills typically use propane or natural gas to provide heat to a grilling surface, such as grill grates or a griddle. It is also known to place a stone cooking surface in a grill in order to provide a stone cooking surface that is often preferred for cooking pizzas. In this regard, the gas grill acts much like an oven.

Some cooking stones are mounted in the oven for rotation relative to an outer housing and relative to a heat source, such as a gas burner or burning wood.

### SUMMARY OF THE INVENTION

The present invention provides a cooking oven comprising a housing defining a first central axis, and a cooking surface positioned in the housing and having a second central axis offset from the first central axis. Preferably, the housing is cylindrically shaped and the cooking surface is disc shaped and mounted for rotation relative to the housing. In one embodiment, a rear edge of the cooking surface is spaced from a rear of the housing to define a rear gap, and a front edge of the cooking surface is spaced from a front of the housing to define a front gap smaller than the rear gap. A heat deflector can be mounted in the housing below the cooking surface, and a heat source can be positioned between the heat deflector and the cooking surface. A position of the heat source relative to the cooking surface is preferably adjustable. The oven can include a second or upper cooking surface (e.g., substantially stationary) above the cooking surface.

In yet another embodiment, the cooking oven includes a third cooking surface positioned in the housing above the second cooking surface. Preferably, both the second and third cooking surfaces are substantially stationary relative to the housing during use, and are offset relative to the first cooking surface. In this regard, the second and third cooking surfaces can be aligned with the housing.

### BRIEF DESCRIPTION OF THE DRAWINGS

FIG. 1 is a front right perspective view of a gas oven embodying the present invention.

FIG. 2 is a front left perspective view of a gas oven embodying the present invention.

FIG. 3 is a rear left perspective view of a gas oven embodying the present invention.

FIG. 4 is a rear right perspective view of a gas oven embodying the present invention.

FIG. 5 is an exploded view of the oven of FIG. 1 with a portion shown in section.

FIG. 6 is a section view taken along line 6-6 in FIG. 1.

FIG. 7 is a section view taken along line 7-7 in FIG. 1.

FIG. 8 is an exploded view of certain parts of the gas oven.

FIG. 9 is a perspective view of an alternative configuration of the oven shown in FIGS. 1-8.

FIG. 10 is a section view taken along line 10-10 in FIG. 9.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

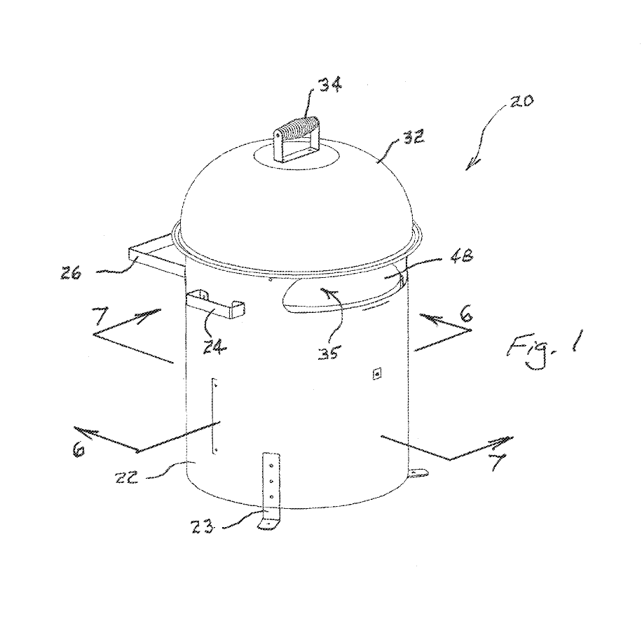

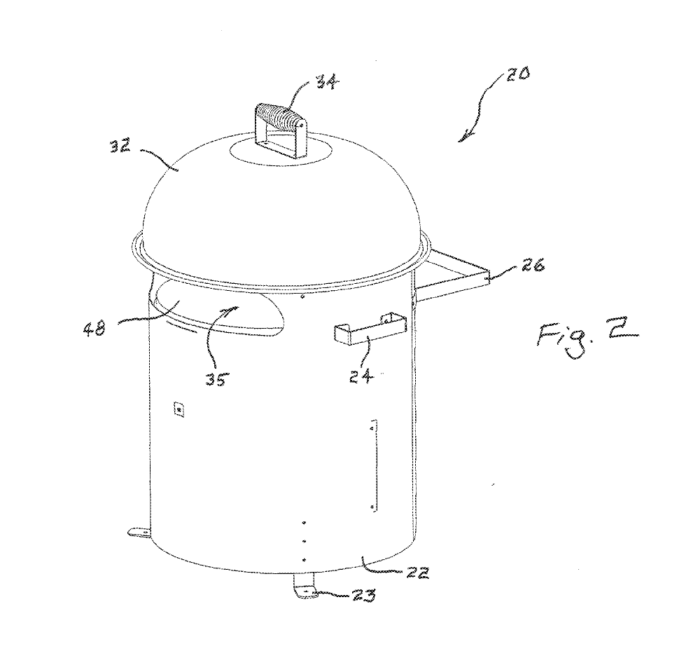

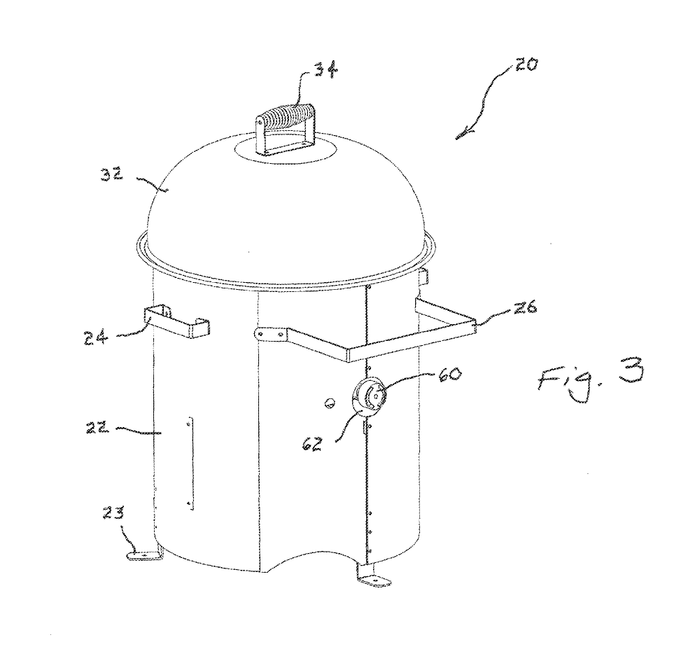

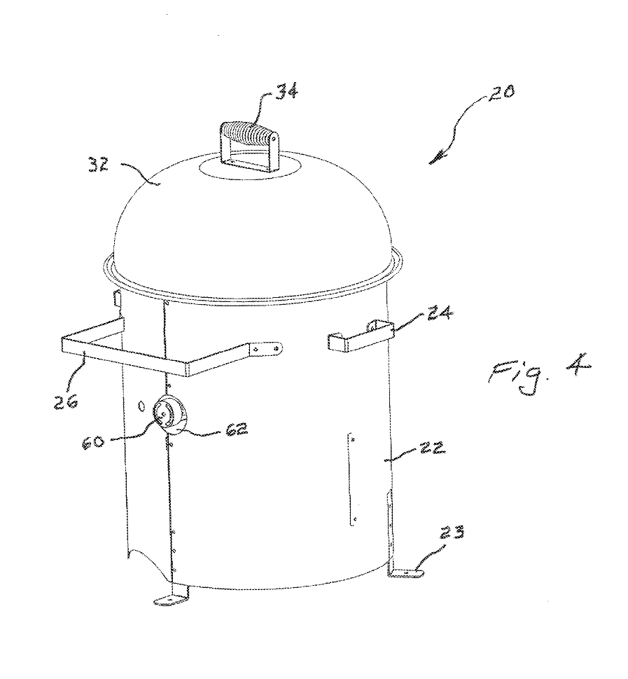

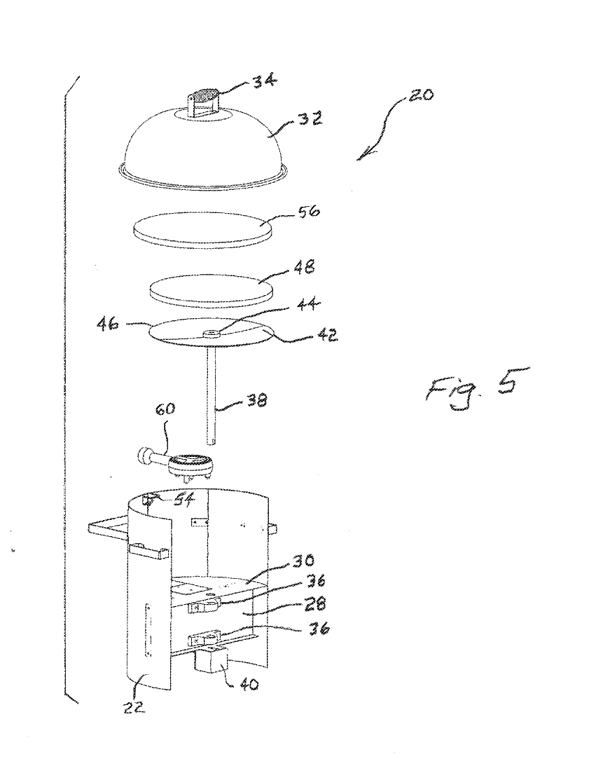

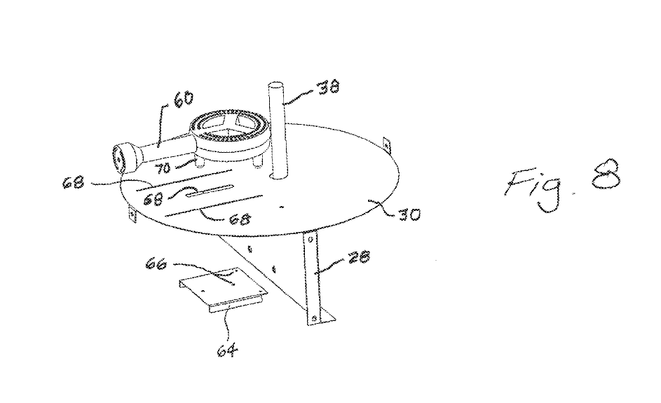

FIGS. 1-8 illustrate a gas oven 20 having a housing 22, three legs 23 for supporting the housing 22 on a surface, two side handles 24 for transporting the oven 20, and a rear handle 26. A bearing support 28 (FIGS. 5-8) extends across a lower portion of the housing 20, and a disk-shaped heat deflector 30 is secured to the inside of the housing 20. A lid 32 is dimensioned to fit over the top of the housing 20, and a lid handle 34 facilitates lifting the lid 32. The housing 22 has a front opening 35 that facilitates inserting food into the oven 20.

The oven further includes pillow block bearings 36 mounted on the bearing support 28, a rotating shaft 38 rotationally mounted in the bearings 36, and an electric motor 40 configured to provide rotation to the rotating shaft 38. A cup-shaped rotor 42 (FIGS. 5-7) is secured to the upper end of the rotating shaft 38 such that rotation of the rotating shaft 38 results in rotation of the rotor 42. A central portion of the rotor includes a central support 44, the upper surface of which is substantially co-planar with an outer edge 46 of the rotor 42.

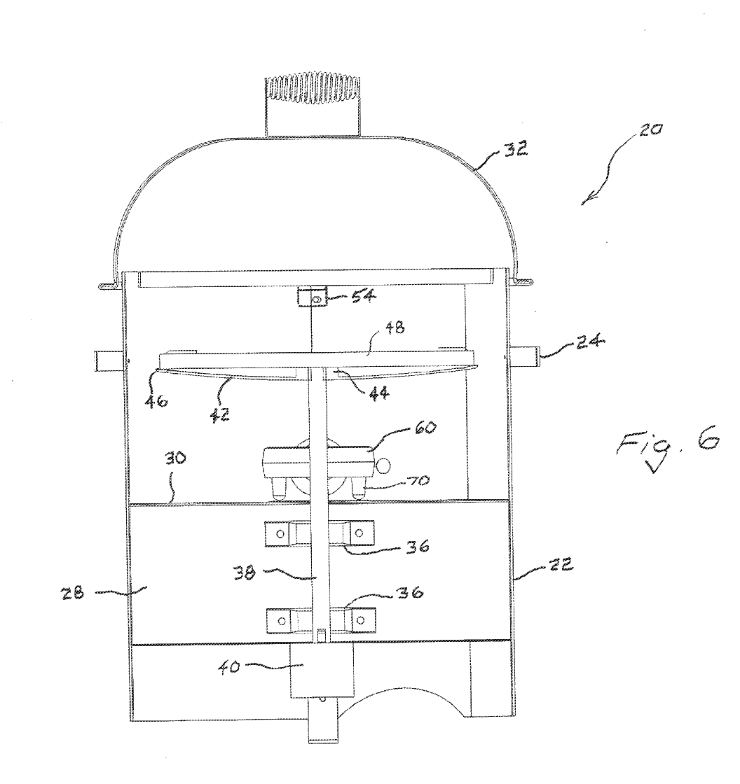

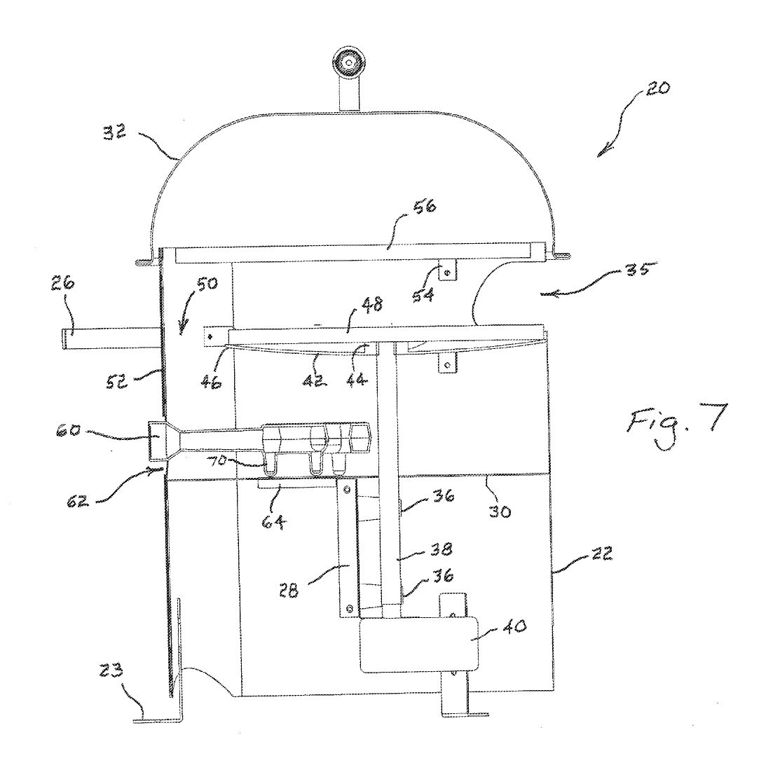

A rotating cooking surface in the form of a rotating stone 48 is positioned on the rotor 42 and will rotate with the rotor 42. As best shown in FIG. 6, the rotating shaft 38, rotor 42, and rotating stone 48 are substantially centered between the left and right sides of the housing 22. However, as best shown in FIG. 7, the rotating shaft 38, rotor 42, and rotating stone 48 are offset relative to the front and rear of the housing 22 such that there is a substantial gap 50 between the rotating stone and the rear 52 of the housing 22.

The oven 20 further includes three stationary stone supports 54 spaced around the inner surface of the upper portion of the housing 22. The stationary stone supports 54 are adapted to support an upper cooking surface in the form of a stationary stone 56. While the stationary stone 56 merely rests upon the stationary stone supports 54, and thus can be moved relative to the housing 22, the stationary stone 56 is designed to be stationary during the cooking process. Unlike the rotating stone 48, the stationary stone 56 is centered in the housing 22.

The oven 20 further includes a burner 60 positioned inside the housing 22 and resting upon the heat deflector 30 adjacent the rotating shaft 38. In the illustrated embodiment, the burner is positioned between the rotating shaft 38 and the rear 52 of the housing 22. The rear 52 of the housing 22 includes a rear opening 62 to allow the passage of gas (e.g., a gas hose) and air to the burner 60 for the combustion process. Heat generated by the burner 60 will be provided to a rear portion of the rotating stone 48, and rotation of the stone 48 will result in the heat being provided around the entire circumference of the stone 48. Heat generated by the burner 60 will also rise and heat the stationary stone 56 to a temperature lower than the temperature of the rotating stone 48. In a preferred embodiment, the rotating stone 48 can be heated to a temperate of about 750-900 degrees, and the stationary stone 56 can be heated to a temperature of about 400-600 degrees Fahrenheit.

An adjustment plate 64 is positioned below the heat deflector 30 in alignment with the burner 60. The adjustment plate 64 includes openings 66 aligned with slots 68 in the heat deflector 30. Fasteners (e.g., screws or bolts, not shown) can be inserted through the openings 66 in the adjustment plate 64, through the slots 68 in the heat deflector 30, and into threaded holes in the legs 70 of the burner 60. This arrangement allows adjustment of the position of the burner 60 relative to the rotating stone 48.

In operation, the burner 60 directly heats the rotating stone 48 and also heats the surrounding air to create convection in the oven. Specifically, air heated by the burner will flow through the gap 50 toward the stationary stone 56 to provide heat to the stationary stone 56. The heat is then deflected downward onto the upper surface of the food placed on the rotating stone 48. Eventually, the heated air passes out of the oven through the opening 35, thereby creating a convective heat flow from the burner 60 to the stationary stone 56 and upper surface of the rotating stone 48.

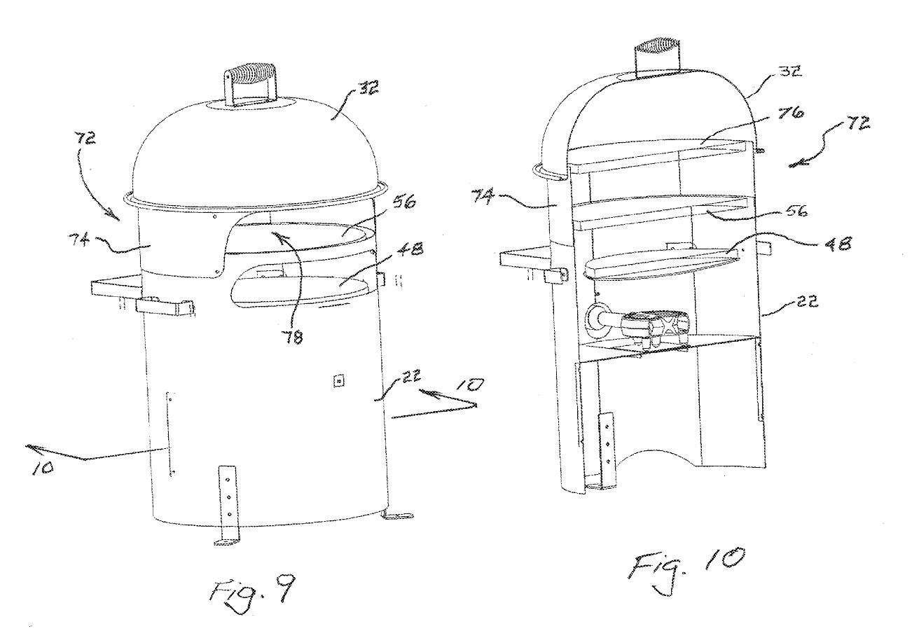

FIGS. 9-10 illustrate an alternative configuration of the oven illustrated in FIGS. 1-8. In this configuration, the lid 32 is removed, and the upper end of the housing 22 is provided with an upper section 72 having an upper housing 74 and an upper stone 76. The upper housing 74 is secured to the upper end of the housing 22 and includes a cutout 78 for providing access to the stationary stone 56 without the need to remove the lid 32. The upper stone 76 is supported on upper stone supports (not shown) that are essentially the same as the stationery stone supports 54 that support the stationary stone 56. Like the stationary stone 56, the upper stone 76 is centered relative to the housing 22 and the upper housing 74. The upper end of the upper housing 74 is dimensioned to be substantially the same size and shape as the upper end of the housing 22 so that the lid 32 fits securely on the upper end of the upper housing 74. With the illustrated arrangement, it is possible to heat the rotating stone 48 a temperate of about 750-900 degrees, the stationary stone 56 to a temperature of about 400-600 degrees Fahrenheit, and the upper stone 76 to about 300-400 degrees F.

Various features of the invention are set forth in the following claims.

1. A cooking oven comprising:
a housing defining a first central axis; and
a cooking surface positioned in the housing and having a second central axis offset from the first central axis.

2. The cooking oven of claim 1, wherein the housing is cylindrically shaped.

3. The cooking oven of claim 1, wherein the cooking surface is disc shaped.

4. The cooking oven of claim 1, wherein the cooking surface is mounted for rotation relative to the housing.

5. The cooking oven of claim 1, wherein a rear edge of the cooking surface is spaced from a rear of the housing to define a rear gap, and wherein a front edge of the cooking surface is spaced from a front of the housing to define a front gap smaller than the rear gap.

6. The cooking oven of claim 1, further comprising a heat deflector mounted in the housing below the cooking surface.

7. The cooking oven of claim 6, further comprising a heat source positioned between the heat deflector and the cooking surface.

8. The cooking oven of claim 7, wherein a position of the heat source relative to the cooking surface is adjustable

9. The cooking oven of claim 1, further comprising an upper cooking surface above the cooking surface

10. The cooking oven of claim 8, wherein the upper cooking surface is substantially stationary relative to the housing.

11. A cooking oven comprising:
a housing;
a first cooking surface positioned in the housing;
a second cooking surface position in the housing above the first cooking surface; and
a third cooking surface positioned in the housing above the second cooking surface.

12. The cooking oven of claim 11, wherein the housing defines a housing central axis and the first cooking surface defines a first central axis offset from the housing central axis.

13. The cooking oven of claim 11, wherein the first cooking surface is mounted for rotation relative to the housing.

14. The cooking oven of claim 11, wherein a rear edge of the first cooking surface is spaced from a rear of the housing to define a rear gap, and wherein a front edge of the first cooking surface is spaced from a front of the housing to define a front gap smaller than the rear gap.

15. The cooking oven of claim 11, wherein the second and third cooking surfaces are substantially stationary relative to the housing.

16. The cooking oven of claim 11, wherein the second and third cooking surfaces define second and third central axes, respectively that are each aligned with the housing central axis.
